(19) United States
(12) Patent Application Publication
(10) Pub. No.: US 2010/0013737 A1
(43) Pub. Date: Jan. 21, 2010

(54) DEVICE FOR THE COLLECTION, STORAGE AND OUTPUT OF ENERGY

(76) Inventor: Mahesh Chandra Dwivedi, Uttar Pradesh (IN)

Correspondence Address: GREENLEE WINNER AND SULLIVAN P C, 4875 PEARL EAST CIRCLE, SUITE 200, BOULDER, CO, 80301, US

(21) Appl. No.: 12/376,245

(22) PCT Filed: Jul. 6, 2007
(86) PCT No.: PCT/IB07/03728

§ 371 Date: Sep. 30, 2009

(30) Foreign Application Priority Data
Aug. 4, 2006 (DE) 10 2006 036 463.5

(51) Int. Cl. H02J 17/00

(52) U.S. Cl. 343/908

(57) ABSTRACT

The invention relates to a device for collection, storage and output of different forms of electromagnetic energy, comprising a collector arrangement and a storage arrangement. According to the invention, electrical energy is collected as efficiently as possible on a commercial scale without the use of raw materials, by providing a conductor (1), forming a closed circuit for supply of electric users with electrical energy for the collector arrangement and/or the storage arrangement.

The invention concerns a device for the collection, storage and output of different forms of electromagnetic energy, with a collector arrangement and a storage arrangement.

The invention moreover concerns the use of a device of the kind cited in the introduction in an exhaust system of an internal combustion engine.

Furthermore the invention concerns the use of the device cited in the introduction for purposes of increasing performance.

A rising requirement exists for the provision of energy to meet the needs of domestic use and potential applications in the private sector. Up to the present time the energy required is generated mainly by the combustion of fossil carbon materials. What is disadvantageous here is that these raw materials are in decline and the environment is being burdened with contaminants, in particular greenhouse gases. The utilisation of other energy sources, such as atomic energy, likewise harbours significant risks through the possible release of harmful radiation and radioactive materials.

The object of the invention is therefore to specify a device and a use of the kind cited in the introduction, with the aid of which electrical energy can be provided as efficiently as possible, and on a commercial scale, without the consumption of raw materials.

The object is achieved in a device of the generic kind, in that a device is proposed for the collection, storage and output of various forms of electromagnetic energy with a collector arrangement and a storage arrangement, wherein a conductor forming a closed electrical circuit for purposes of supplying electrical loads with electrical energy is envisaged for the collector arrangement and/or storage arrangement.

Our environment is continuously surrounded by large quantities of energy, without our being aware of it and without this energy being utilised commercially. The energy occurs predominantly as electromagnetic oscillations, which are produced both in nature and also by human activity. It is, for example, known that we are continuously surrounded by cosmic radiation that originates in space. Likewise nature produces large quantities of electrical charge in the atmosphere, and the earth is continuously surrounded by its own fluctuating magnetic field. Examples of electromagnetic energy generated by human activity are hertzian and radio, waves and electric fields generated by the operation of machines. Surprisingly the various forms of energy can be used and stored at the same time by means of the closed conductors. Thus, if the conductor moves in an artificial or natural magnetic field, or the conductor is subjected to a varying magnetic field, a voltage is induced in the former. Likewise the closed conductor acts as an aerial and in this manner can convert electromagnetic waves of a suitable frequency into electrical energy. Furthermore the conductor can serve as a probe for the accommodation of electrical charges, which by means of polarisation generate an electrical voltage and during discharge generate a usable current. However, the conductor serves not only for the accommodation and collection of energy, but also serves as a storage medium for the energy gained. On the one hand, the energy can, as conditioned by the closed conductor, be stored as a circulating ring current. The storage duration is then determined by the resistance of the conductor and the voltage. The energy can also be stored such that the conductor acts as a condenser as a result of its capacitance, and thus, for example, accommodates positive charges on the outer face and negative charges on the inner face. In this manner the energy can be used in that a load is connected to each of two points on the conductor, thus, for example, on the inner face and the outer face. With this equipment, therefore, an energy requirement can be met and at the same time problems of environmental contamination can be solved in a simple manner. The energy thus provided is moreover harmless and does not generate any hazards.

The invention reduces the current level of energy consumption. This technology can be introduced in all fields in which energy is consumed. For example: in the car, in the motorcycle, in the domestic sector (e.g. dishwasher, washing machine, dryer, lawnmower), in factories, in tractors, in missiles, etc. In the car and motorcycle the invention can, for example, be used as additional exhaust gas treatment and for purposes of increasing performance.

The above-cited advantages can be achieved in a simple manner, if the conductor is designed as a closed ring structure.

Cost-effective manufacture is achieved if the closed ring conductor consists of a pipe clamp, in particular in two parts, preferably connected together by means of nuts and bolts. This form of manufacture can be implemented with very little outlay, and is thus also suitable for private use. The design of the equipment requires no extensive technical knowledge. Also for non-professional and poor people in the developing countries, for example, a sufficient supply of energy is thus made possible.

Another form of embodiment consists in that the conductor has a quadratic base plate and two mutually opposing, triangular, side plates, with their bases in each case connected in a conducting manner to the base plate, and at their upper tips connected in a conducting manner to each other, and thus is designed as an essentially pyramidal structure. By this means the usable surface area is on the one hand increased in comparison to the ring structure, as a result of which the energy yield is improved. A further advantage ensues from the form of a pyramid open on two opposing sides. The oscillations can enter through the openings into the pyramid and be converted into energy. Energy that is not at first converted can be reflected and then absorbed, as a result of which the efficiency is increased.

The conductor can be matched in form and size to the energy source in question. Thus, for example, the resistance is varied around the perimeter of the ring structure.

To increase the total energy a plurality of charged conductors can be connected together in parallel or in series, according to whether the loads in question require a high current or a high voltage. A number of conductors can also, of course, be connected together in series to form a conductor pack and these packs in turn connected together in parallel. Likewise the differing advantages of the various forms of embodiment can be combined, such that, for example, the closed ring structure is combined with the pyramid structure, i.e. is connected together with the latter in series or in parallel.

The object underlying the invention is likewise achieved by the use of a device according to the invention in an exhaust system of an internal combustion engine, in particular of a motor vehicle, for purposes of exhaust gas treatment.

During the combustion process in which fossil fuels such as petrol or diesel are burnt, under certain pressure and temperature conditions oxides of nitrogen and other substances harmful to the environment are generated as a result of incomplete combustion. These substances can, for example, contribute to acid rain, low altitude ozone, or, quite generally, to smog. It is therefore desirable that combustion in internal combustion engines proceeds to completion, so that carbon dioxide and water, and possibly nitrogen, are the only reaction products to occur. If according to the use in accordance with the invention the device in accordance with the invention is used in the exhaust system of an internal combustion engine, the exhaust gases can be treated by the promotion of complete combustion of the contaminants by reason of the energy stored in the device.

The object underlying the invention is likewise achieved by the use of a device according to the invention to increase the performance of an internal combustion engine.

By the use of a device for the storage and output of energy in accordance with the invention in an internal combustion engine the combustion process can be optimised in the case of fossil fuels, such that complete combustion of the fossil fuels takes place to form the reaction products carbon dioxide, water, and possibly nitrogen. Since the energy content of the fossil fuels is thus optimally exploited, an increase in performance of the internal combustion engine ensues with advantage in accordance with the invention.

The invention is described in an exemplary manner with reference to a drawing, wherein further advantageous details can be extracted from the figures of the drawing.

Here parts with the same function are supplied with the same reference symbols.

Individually the figures of the drawing show:

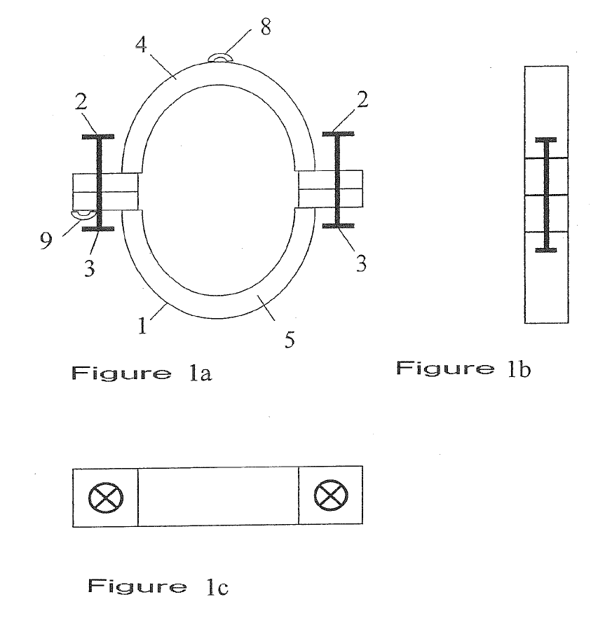

FIG. 1a a front view of the closed ring conductor;

FIG. 1b a side view of the closed ring conductor as in FIG. 1a;

FIG. 1c a plan view of the closed ring conductor as in FIG. 1a;

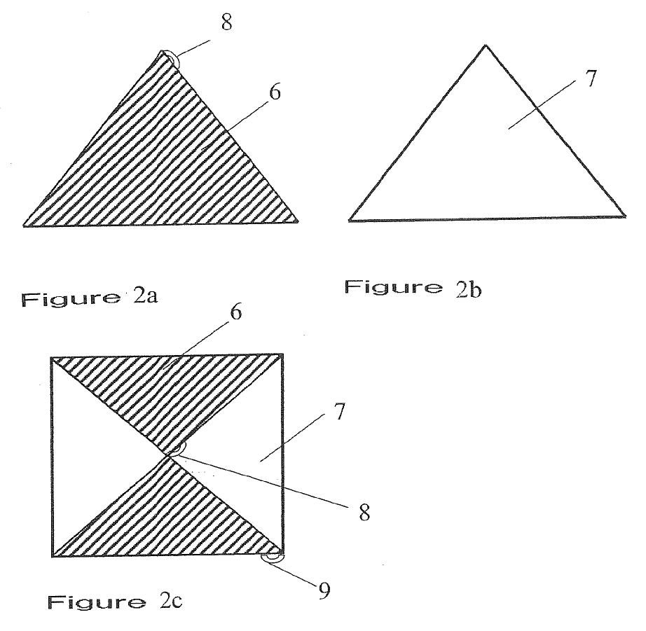

FIG. 2a a front view of the pyramidal conductor;

FIG. 2b a side view of the pyramidal conductor as in FIG. 2a;

FIG. 2c a plan view of the pyramidal conductor as in FIG. 2a.

FIG. 1a shows a front view of the closed ring conductor 1. This consists of a pipe clamp 1, which consists of an upper half 4 and a lower half 5. The two halves are connected together in a conducting manner by means of nuts 2 and bolts 3. The pipe clamp consists of metal, preferably in sheet form. This form of manufacture can be implemented with very little means, and is thus also suitable for private use. If the clamp is subjected to a varying magnetic field, then a voltage will be induced in the former. As a result of the ring structure a closed electrical circuit ensues. The voltage drops across the resistance of the ring conductor, wherein the resistance of the latter can be varied over its perimeter. In order to be able to use the current, terminals 9, 8 are fitted in each case to the lower and upper halves 4, 5 of the pipe clamp. A current load, such as, for example, an item of electrical kitchen equipment, can be connected to these.

Likewise a voltage is generated in the pipe clamp if the latter is subjected to electromagnetic oscillations, since in this case it acts as an aerial.

However, the conductor serves not only for the accommodation and collection of energy, but also as a storage medium. The energy can, on the one hand, as conditioned by the closed conductor, be stored as a circulating ring current. The storage duration is then determined by the resistance of the conductor and the voltage. The energy can also be stored in that the conductor acts as a condenser as a result of its capacitance, and accommodates differing charges on the outer face and inner face in each case.

FIG. 1b and FIG. 1c show respectively a side view and plan view of the closed ring conductor as in FIG. 1a.

FIG. 2a shows a front view of a further form of embodiment of the conductor. This consists in that the conductor has a quadratic base plate (not visible) and two mutually opposing, triangular, side plates 6 with their bases in each case connected in a conducting manner to the base plate and at their upper tips connected in a conducting manner to each other, and so is designed as a pyramidal structure. Since the pyramid only has two side plates 6, two triangular openings 7 ensue. The length of the base plate is some 5 to 10 cm. As a result of the pyramidal structure the usable surface area is increased in comparison to the ring structure. By this means the energy yield is improved. A further advantage ensues in that the pyramid has openings 7 on two opposing sides. Electromagnetic oscillations can enter through the openings 7 into the pyramid and be converted into energy. Energy that is not at first converted is reflected and then absorbed, as a result of which the efficiency is increased. Terminals 8, 9 are located in each case on the upper face and on the lower face of the side plates, to which terminals a current load can be connected.

By means of the invention energy from the environment not otherwise used can be supplied for profitable utilisation. Natural energy contributions or contributions occurring as a by-product are collected and stored without any expenditure, and the energy thus gained is provided for utilisation on a commercial scale with only little expenditure.

### REFERENCE SYMBOL LIST

1 Conductor

2 Nut

3 Bolt

4 Upper clamp half

5 Lower clamp half

6 Side plate

7 Opening

8 Terminal

9 Terminal

1. A device for the collection, storage and output of different forms of electromagnetic energy, with a collector arrangement and a storage arrangement,
characterised in that for the collector arrangement and/or the storage arrangement a conductor (1) forming a closed electrical circuit is provided for the supply of electrical loads with electrical energy.

2. The device according to claim 1,
characterised in that the conductor is designed as a closed ring structure.

3. The device according to claim 1 or 2,
characterised in that the closed ring conductor (1) consists of a pipe clamp (4, 5), in particular in two parts, preferably connected together by means of nuts (2) and bolts (3).

4. The device according to claim 1,
characterised in that the conductor (1) has a quadratic base plate and two mutually opposing, triangular, side plates (6) with their bases in each case connected in a conducting manner to the base plate and at their upper tips connected in a conducting manner to each other, and so is designed as an essentially pyramidal structure.

5. The device according to one or a plurality of the preceding claims,
characterised in that the conductor (1) is matched in form and size to the energy source in question.

6. The device according to one or a plurality of the preceding claims,
characterised in that a plurality of conductors (1) are connected together in series or in parallel to increase the total energy.

7. The use of a device according to one of the claims 1 to 6 in an exhaust system of an internal combustion engine, in particular of a motor vehicle, for purposes of exhaust gas treatment.

8. The use of a device according to one of the claims 1 to 6 for purposes of increasing the performance of an internal combustion engine.
